(19) United States
(12) Patent Application Publication
(10) Pub. No.: US 2018/0263194 A1
(43) Pub. Date: Sep. 20, 2018

(54) GREEN INDOOR CULTIVATION

(71) Applicant: SKANSKA SVERIGE AB, STOCKHOLM (SE)

(72) Inventors: HANS PILEBRO, ENEBYBERG (SE); TOBIAS STRAND, FARSTA (SE)

(21) Appl. No.: 15/542,603

(22) PCT Filed: Feb. 4, 2016
(86) PCT No.: PCT/SE2016/050087

§ 371 Date: Jul. 10, 2017

(30) Foreign Application Priority Data
Feb. 5, 2015 (SE) 1550129-9

(51) Int. Cl. A01G 9/24; A01G 9/20; F28D 20/00; H02S 10/00

(52) U.S. Cl. CPC A01G 9/246; A01G 9/20; A01G 9/243; H02S 20/23; F28D 20/0052; H02S 10/00; A01G 9/247

(57) ABSTRACT

The present invention relates to a cultivation structure and a method for operating a cultivation structure comprising an area for cultivation, the cultivation structure being connected to a subterranean thermal energy storage. The arrangement comprises: a heating-cooling system for controlling an indoor climate of the structure, wherein the heating-cooling system is arranged to cool air in the structure by transporting heat from the air in the structure into the subterranean thermal energy storage and wherein the heating-cooling system is arranged to heat air in the structure by transporting heat from the subterranean thermal energy storage into the structure.

### TECHNICAL FIELD

The present invention generally relates to a cultivation structure and a method for operating a cultivation structure, the cultivation structure being connected to a thermal energy storage, and in particular to a cultivation structure and a method for operating a cultivation structure comprising an area for cultivation in an environmental friendly and energy efficient way.

### BACKGROUND ART

The idea of growing plants in environmentally controlled areas has existed since Roman times. Nowadays, greenhouses are used having glass or plastic roofs and walls. The greenhouses are heated by incoming sun light. The energy in the light is partly transformed to heat and partly utilized in the photosynthesis of the plants in the greenhouse. A minor part of light is reflected out via the glass of the greenhouse to the surroundings.

The roof and the walls create a climate shell and an indoor climate. An energy balance in the indoor climate is created between the heat from sun light, lighting, people, plants and the heat transmitted out through the climate shell (e.g. through windows) and ventilation losses.

During the warm season, often the air in the greenhouses gets far too warm for the plants. The photosynthesis process transforms carbon dioxide and water into carbon hydrates (sugar, fibres etc.) and oxygen (6CO₂+6H₂O=>C₆H₁₂O6+6O₂) using energy from light. If the amount of light is insufficient, the process is reversed (respiration), and CO₂ and energy (heat) is produced. Another process in plants is the transpiration which includes transporting water and nutrients to leaves of the plants. The photosynthesis process depends on optimal conditions for light, carbon dioxide, air humidity and temperature. At too high temperatures and low air humidity the process is throttled by closing the stomas in the leaves resulting in a dramatically reduction of the photosynthesis. In order for the photosynthesis to function properly and improve quality of the resulting fruit and plants, preferably, the temperature should not exceed 25° C. The excess heat is therefore usually aired out by opening windows and doors in the greenhouse. However, by opening the greenhouse, vermin is let into the greenhouse which makes it difficult to use organic methods. Any ventilation of the greenhouse also ventilates out added CO₂ gas, resulting in greenhouse gas emission. Water is also lost during ventilation, increasing the water usage for the green house.

Furthermore, to achieve a temperature below outdoor temperature active cooling is needed. If the climate shell is poorly insulated, the amount of active cooling is increased. Furthermore, even though the growing season is prolonged when using a greenhouse, it is still relatively short in the north due to the limited amount of sun light and the cold climate.

To prolong the season, artificial light and heating is applied in the greenhouse and water and nutrition is added. The additional light increases the electrical consumption and the internal heat gain, which results in a cooling need outside heating seasons. An additional way to improve growth is by adding carbon dioxide, CO₂, to the air which improves the number of harvests and the output.

Greenhouses having glass roofs and walls have low heat resistance compared to conventional buildings, thus, during heating seasons, more heating is needed than for conventional buildings. Some of the additional light is also transmitted out from the greenhouse glass.

In intense sunlight, the irradiation from the sun exceeds the optimum level for the plants. For this reason sunscreens are used which reduces the amount of incoming sun light to the plants.

Heat is mostly added during the cold season, increasing energy consumption and heat power during a time when it is needed everywhere in the society, increasing peak loads. When heating the greenhouse, water may condense on the inside glass surface which reduces the amount of incoming irradiation. Fungus and algae may grow in the wetted and high humidity areas. Constant high humidity is normally avoided by ventilation or increased temperature.

### SUMMARY OF THE INVENTION

In view of the above, an objective of the invention is to solve or at least reduce one or several of the drawbacks discussed above. Generally, the above objective is achieved by the attached independent patent claims.

According to a first aspect, the present invention is realized by a cultivation structure comprising an area for cultivation connected to a subterranean thermal energy storage. The structure comprises: a heating-cooling system for controlling an indoor climate of the structure, wherein the heating-cooling system is arranged to cool air in the structure by transporting heat from the air in the structure into the subterranean thermal energy storage, and wherein the heating-cooling system is arranged to heat air in the structure by transporting heat from the subterranean thermal energy storage into the structure.

The cultivation structure provides an environment-friendly solution. Since excess heat may be stored in the subterranean thermal energy storage, the heat may be used when there is a need for heating. Furthermore, the air in the structure may be cooled without opening up the structure which is advantageous in that carbon dioxide is not aired out, vermin is not let in, and in that the air in the structure may be cooled to a temperature below the outdoor temperature.

Furthermore, when the structure needs heating, the heating-cooling system uses heat stored in the thermal energy storage which is environmentally desirable. This heat may have been generated in the structure. Heating with oil, gas, or other fossil energy sources is then not necessary which is also beneficial to the environment.

Additionally, the cultivation structure enables heat recovery during food production (cultivation of eatable plants). By cultivating eatable plants in the cultivation structure, the result may be that food production is used as a heat source. It is to be noted that also plants that are inedible may be cultivated in the cultivation structure.

The cultivation structure may further comprise the subterranean thermal energy storage having a vertical temperature gradient, the heating-cooling system comprising a circulation system arranged to retrieve a fluid from a first vertical level in the subterranean thermal energy storage, to circulate the fluid in the structure such that heat and/or cold is exchanged between the fluid and the air in the structure, and to return the fluid to a second vertical level in the subterranean thermal energy storage.

There is thereby a possibility of optimizing the storage of energy by choosing at which temperature levels the fluid is to be retrieved and released, all depending on the specific conditions in the grid and in the energy storage at a given period in time

The cultivation structure may further comprise a plurality of light sources arranged to illuminate the area for cultivation, and a plurality of solar cells arranged in connection to the structure and arranged to supply the plurality of light sources with power.

The light sources may, e.g., be LED:s (Light Emitting Diode), sodium-vapor lamps, fluorescent lamps or any other lamps suitable for illumination of the area of cultivation. LED:s are electricity-saving and do not emit as much heat as, e.g., sodium-vapor lamps and, thus, the need for cooling is decreased. If sodium-vapor lamps are used, the need for cooling is increased. Additionally, the solar cells enable running the cultivation structure, at least partly, using solar energy.

LED:s may be arranged to emit light of different wavelengths so that the light illuminating the area for cultivation may be adapted to what is cultivated.

The heating-cooling system may comprise a control system arranged to control the indoor climate and be arranged to control at least one of humidity, temperature, light, and carbon dioxide in the cultivation structure. This is advantageous since the indoor climate influences the conditions of growth of plants cultivated in the cultivation structure. Growth cycles of plants cultivated in the cultivation structure may be manipulated in different ways.

The control system may comprise a plurality of measuring units arranged to measure at least one of temperature, humidity, light, and carbon dioxide. This is advantageous in that information regarding temperature, humidity, light, and carbon dioxide can be provided to the control system.

The thermal energy storage and/or the cultivation structure may be connected to at least one residential house. The control system may be set to cool the air in the cultivation structure mornings. This is advantageous since many people shower in the mornings. Additionally or alternatively, the control system may be set to heat the air in the cultivation structure evenings. This is advantageous since many people cook in the evenings.

The heating-cooling system may comprise a control system arranged to control the indoor climate based on at least one from the group of: time of night, time of day, point in time of growth cycle for what is cultivated, and temperature of air in the structure. What is cultivated may be at least one plant, in particular at least one eatable plant. The cultivation structure allows for adapting heating and/or cooling during the growth cycle of what is cultivated. Also, the plants that are cultivated may e.g. be annual or perennial and the control of the indoor climate may be adapted to that. In one embodiment, controlling the indoor climate comprises adapting a temperature of the air in the structure.

The cultivation structure may further comprise the subterranean thermal energy storage having a vertical temperature gradient and an internal combined heating and cooling machine, said internal combined heating and cooling machine being adapted for retrieving a fluid having a first temperature from the energy storage, and returning heated fluid having a second higher temperature and cooled fluid having a third lower temperature, and the plurality of solar cells being arranged to supply the internal combined heating and cooling machine with power. There is thereby a possibility of optimizing the storage of energy by choosing at which temperature levels the fluid is to be retrieved and released, all depending on the specific conditions in the grid and in the energy storage at a given period in time. Other advantages are the utilization of surplus electrical energy in the grid and the possibility of easily balancing the production of electricity against the consumption of electrical energy.

The solar cells may be at least partly translucent to sun light. This is advantageous in that the solar cells may be arranged on parts of the structure that are transparent.

The solar cells may be arranged on top of the structure and/or on sides of the structure. In one embodiment, the solar cells may be arranged on windows and/or walls of the structure. In one embodiment, windows of the structure comprise solar cells.

The structure may be at least partly opaque. This is advantageous in that less light is lost through transmission through transparent parts in the cultivation structure. Increased building heat transmission resistance increases the amount of heat that may be recovered and transported to the thermal energy storage. The heat in the thermal energy storage may be utilized later for heating the cultivation structure when there is a need for that which has the advantage that less or no heat needs to be imported to the cultivation structure from e.g. a district heating system. Additionally, heat generated in the cultivation structure and stored in the thermal energy storage may be transported elsewhere. This heat could then be used for heating of buildings, domestic hot water and other purpose, replacing other heat sources such as fossil fuels. To a well-insulated cultivation structure no external heat may need to be added and heat could be exported from the thermal energy storage all hours during the year. Hence, in one embodiment, the cultivation structure may be opaque.

In one embodiment, about 10% of the cultivation structure is translucent. This is advantageous in that conditions are balanced. Sufficient light is let into the cultivation structure at the same time as relatively little heat is lost through transmission.

A roof of the structure may be at least one from the group of: transparent and dome-shaped. Having a transparent roof enables inlet of light through the roof. In the embodiment with a transparent roof, the solar cells may be at least partly transparent.

The structure may be at least one from a building, a part of a building, a green house, a tunnel, a part of a tunnel, a covered pit, and an extraterrestrial covered crater. Thus, the cultivation structure is very flexible.

The structure may comprise at least one mirror. This is advantageous in that light may be reflected and directed towards, e.g., plants in the structure.

At least a part of an inside of the structure may have a reflective coating. This is advantageous in that light may be reflected and directed towards, e.g., plants in the structure.

At least a part of the inside of the structure may have a fluorescent coating. This is advantageous in that light frequencies that are less suitable may be converted into more desirable frequencies. As an example, yellow light may be transformed into red light.

The structure may comprise a plurality of climate zones, the climate zones having different temperatures. Thus, different organisms having different requirements in terms of climate may exist in the same structure.

The climate zones may be vertically and/or horizontally arranged. In this way, space in the structure may be used efficiently.

The heating-cooling system may comprise at least one heater-cooler unit. The at least one heater-cooler unit may be arranged to retrieve water from the air of the structure by transforming vapor in the air of the structure into water. This is advantageous in that water is extracted and may be used for other purposes. Furthermore, since the structure is not opened up in order to air out the moisture, vermin is not let in and CO₂ gas is not aired out.

The heating-cooling system may comprise a cooler unit arranged in connection to the structure, wherein the cooler unit may be arranged to retrieve heat from air outside the structure and wherein the heating-cooling system is arranged to transport the retrieved heat into the subterranean thermal energy storage. This is advantageous when it comes to system utilization and efficiency, amount of pipes, cost of investment, coefficient of performance. Additionally, the difference in temperature between liquid retrieved from the subterranean thermal energy storage for cooling the structure and the temperature of the liquid after having it circulated in the cooling unit is increased. Furthermore, if more condensed water is formed outside the structure, more water can be retrieved.

The cooler unit may be arranged to retrieve water from the air outside the structure by transforming vapor in the air surrounding the structure into water. This is advantageous in that even more water is extracted which may be used for other purposes.

The cultivation structure may further comprise an irrigation system. The irrigation system may be arranged to irrigate the cultivation area. The irrigation system may be connected to heating-cooling system and arranged to transport retrieved water from the heating-cooling system to the area for cultivation. It is favorable to the environment that the cultivation structure is able to retrieve water to be used by the irrigation system instead of having it delivered.

The cultivation structure may further comprise a rain collector arranged to retrieve water from rain, the rain collector being connected to the irrigation system and/or the heating-cooling system. It is favorable to the environment that the cultivation structure is able to retrieve water instead of having it delivered.

The irrigation system may be connected to an external water system and be arranged for providing retrieved water to the external water system instead of having it delivered. It is favorable to the environment that the cultivation structure is able to retrieve water.

The area for cultivation may comprise a plurality of sub-areas, the sub-areas being arranged at a plurality of levels in the structure, and at least one of: the plurality of light sources being arranged to illuminate the plurality of sub-areas, and the irrigation system being arranged to irrigate the plurality of sub-areas. In this way, space in the structure may be used efficiently.

The cultivation structure may further comprise an aquaculture connected to the area for cultivation. This is advantageous in that the area for cultivation may be provided with nutrients.

The area for cultivation may comprise a hydroculture system. This is advantageous in that the cultivation may be performed more efficiently.

According to a second aspect, the present invention is realized by a method for operating a cultivation structure comprising an area for cultivation. The method comprises: a heating-cooling system cooling air in the structure by transporting heat from the air in the structure into a subterranean thermal energy storage, and the heating-cooling system heating the air in the structure by transporting heat from the subterranean thermal energy storage into the structure.

The method may further comprise a circulation system retrieving a fluid from a first vertical level in the subterranean thermal energy storage, circulating the fluid in the structure such that heat and/or cold is exchanged between the fluid and the air in the structure, and returning the fluid to a second vertical level in the subterranean thermal energy storage.

The method may further comprise cooling the solar cells by transporting heat from the plurality of solar cells into the subterranean thermal energy storage.

The method may further comprise the heating-cooling system comprising at least one heater-cooler unit, the at least one heater-cooler unit retrieving water from the air of the structure by transforming vapor in the air of the structure into water.

The method may further comprise the heating-cooling system comprising a cooler unit, the cooler unit retrieving heat from air outside the structure, and the heating-cooling system transporting the retrieved heat into the subterranean thermal energy storage.

The method may further comprise the cooler unit retrieving water from the air outside the structure by transforming vapor in the air outside the structure into water.

The method may further comprise transporting retrieved water from the heating-cooling system to the area for cultivation using an irrigation system.

The advantages of the first aspect are equally applicable to the second. Furthermore, it is to be noted that the second aspect may be embodied in accordance with the first aspect, and the first aspect may be embodied in accordance with the second aspect. The cultivation structure may in some cases be referred to as an arrangement.

Other objectives, features and advantages of the present invention will appear from the following detailed disclosure, from the attached claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated. Furthermore, the word “comprising” does not exclude other elements or steps.

### BRIEF DESCRIPTION OF THE DRAWINGS

Other features and advantages of the present invention will become apparent from the following detailed description of a presently preferred embodiment, with reference to the accompanying drawings, in which

FIG. 1 is a perspective view of a cross-section of an embodiment of the inventive system.

FIG. 2a is a perspective view of a cross-section of an embodiment of the inventive system.

FIG. 2b is a perspective view of a part the embodiment of the inventive system of FIG. 2a.

FIG. 3A is a perspective view of a cross-section of an embodiment of the inventive system.

FIG. 3B is a perspective view of an embodiment of the inventive system.

FIG. 4 is a perspective view of an embodiment of the inventive system.

FIG. 5 is schematically illustrates of an embodiment of the inventive system.

FIG. 6 is a perspective view of an embodiment of an inventive structure.

FIG. 7 is a perspective view of an embodiment of an inventive cultivation structure of FIG. 1.

### DETAILED DESCRIPTION OF PREFERRED EMBODIMENTS OF THE INVENTION

The present invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

The inventive cultivation structure, and method, may be able to provide food, heat, cold, light, and/or water. Furthermore, the system is flexible and may, e.g. be arranged at barren places and in different climates. Additionally, all types of plants may be grown in the structure since the indoor climate may be adapted by adapting temperature, moisture, and lighting. Plants that naturally grow in the north may, by using the inventive system and/or method, instead be grown in e.g. Sahara.

A preferable temperature for the photosynthesis is about 20° C. The temperature in the cultivation structure may be adapted to the type of plants grown and to what kind of result is desired.

LED:s (light emitting diodes) are high energy efficient and have a long life time. Furthermore, they provide the possibility of tailoring the light spectrum so that illumination of the plants may be adapted to the type of plant and/or the various steps of growth. The cultivation structure may be made independent of geography and weather. The cultivation structure does not need any electrical or gas heating system. Instead, the internal thermal load from lighting may be balanced to the heating power needed by the cultivation structure.

The inventive cultivation structure comprises an area for cultivation and is connected to a subterranean thermal energy storage. The cultivation structure further comprises a heating-cooling system connected to the subterranean thermal energy storage. The heating-cooling system is arranged to cool air in the structure by transporting heat from the air in the structure into the subterranean thermal energy storage. The heating-cooling system is arranged to heat air in the structure by transporting heat from the subterranean thermal energy storage into the structure.

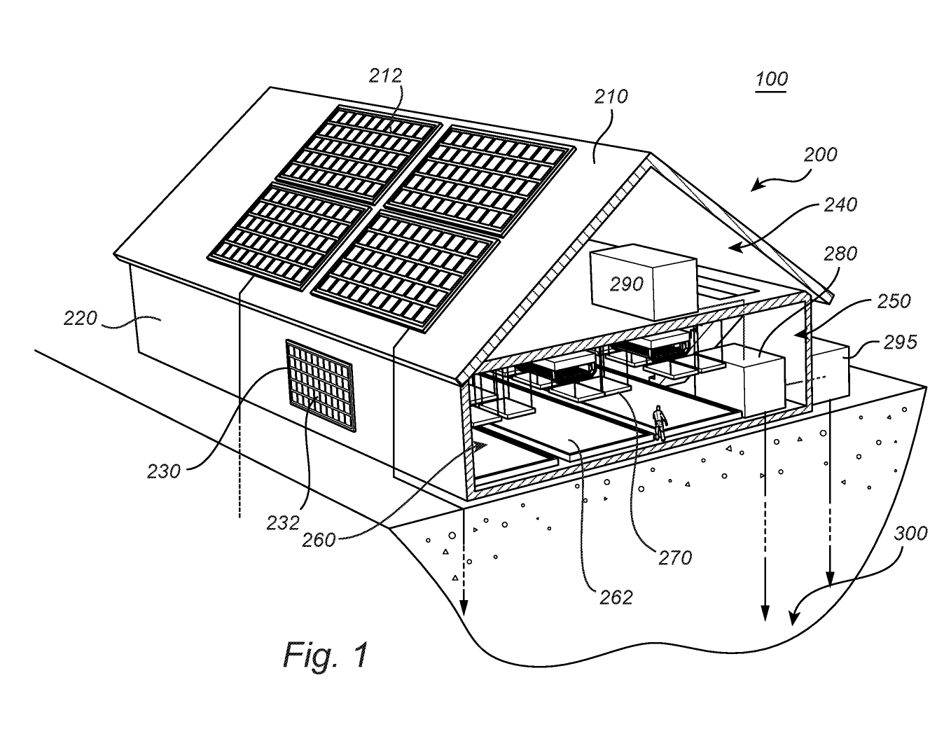

FIG. 1 illustrates an embodiment of the inventive cultivation structure 100. The structure 200 is here an opaque building with roof 210 and walls 220 that may be insulated, and at least one window 230. It is to be noted that in one embodiment, the structure 200 does not comprise any windows.

The roof 210 and the at least one window 230 comprise a plurality of solar cells 212, 232 that may be transparent or at least partly transparent. Hence, sun light may be let into the structure through the solar cells 212, 232. In one embodiment, the entire roof 210 is covered with solar cells.

The structure 100 comprises an attic 240 and a ground floor 250. In the ground floor 250, there is an area 260 for cultivation. A plurality of LED:s 270 are arranged to illuminate the area 260 for cultivation. The plurality of LED:s 270 may e.g. be arranged over the area 260 for cultivation.

The solar cells 212, 232 may be arranged to supply the plurality of LED:s 270 with power. In one embodiment, the solar cells are arranged to, at least partly, supply the plurality of LED:s with power. The solar cells are arranged to convert the energy of solar light into electricity. In one embodiment, the solar cells are directly connected to the LED:s through a transformer. It may be advantageous to instead connect the solar cells to the grid and also connect the LED:s to the grid. In this way, excess electricity may be used elsewhere. It is to be noted that other light sources may be used, such as e.g. sodium-vapor lamps.

The cultivation structure 100 further comprises a heater-cooler unit 280, a cooler unit 290, an external cooler unit 295, and a subterranean thermal energy storage 300 connected to the units 280, 290, 295. The units 280, 290, 295 are included in a heating-cooling system. The heating-cooling system may also comprise pipes connecting the units 280, 290, 295 and/or subterranean thermal energy storage 300. The pipes may extend in the structure. The pipes may be arranged to exchange heat and/or cold between the surrounding and their inside. The pipes may be referred to as a circulation system. It is to be noted that the heating-cooling system may comprise a plurality of heater-cooler units and the plurality of heater-cooler units may be connected in series. The heater-cooler unit 280 is arranged to cool air in the structure 200, in this embodiment the ground floor 250. This may be performed by the arrangement, more particularly the heating-cooling system, retrieving a cooling liquid, e.g. water, from the subterranean thermal energy storage 300. The cooling liquid may, e.g., have a temperature of about 8° C. It is to be noted that also other temperatures are possible. The cooling liquid is then circulated and transported between the subterranean thermal energy storage 300 and the heater-cooler unit 280 using pipes and indirectly heated by the air in the structure. The heated cooling liquid is transported back to the subterranean thermal energy storage. The heated cooling liquid may, e.g., have a temperature of about 18° C. It is however to be noted that also other temperatures are possible.

In one embodiment, the cooling liquid is transported to the attic 240 after having been heated by the air in the ground floor 250. In the attic 240, the cooling liquid is further heated by, e.g., heat from the solar cells, and/or solar heat transmitted through solar cells and/or windows. A pump (not shown) is arranged to pump the cooling liquid from the subterranean thermal energy storage 300 to the structure 200. By further heating the cooling liquid in the attic increases the efficiency of the arrangement since more heat may be transported to the subterranean thermal energy storage 300 using the same amount of pumping power.

In one embodiment, the cooling liquid is in the attic 260 circulated in pipes that extend along the solar cells. In the embodiment of FIG. 1, the cooling liquid is circulated in the cooler unit 290.

In order to yet further increase the efficiency of the arrangement the cooling liquid may be transported to the external cooler unit 295 arranged outside the structure 200 and thereby heated by the air outside the structure.

The heater-cooler unit 280 may be arranged to heat air in the structure 200, in this embodiment the ground floor 250. This may be performed by the arrangement retrieving a heating liquid, e.g. water, from the subterranean thermal energy storage 300. The heating liquid is then circulated and transported between the subterranean thermal energy storage 300 and the heater-cooler unit 280 using pipes and indirectly cooled by the air in the structure. The cooled heating liquid is transported back to the subterranean thermal energy storage.

The subterranean thermal energy storage 300 may be formed in a subterranean medium, such as e.g. rock, bedrock, soil. The subterranean thermal energy storage 300 may comprise at least one subterranean tunnel having a tunnel wall, the subterranean tunnel and the tunnel wall being formed in the subterranean medium.

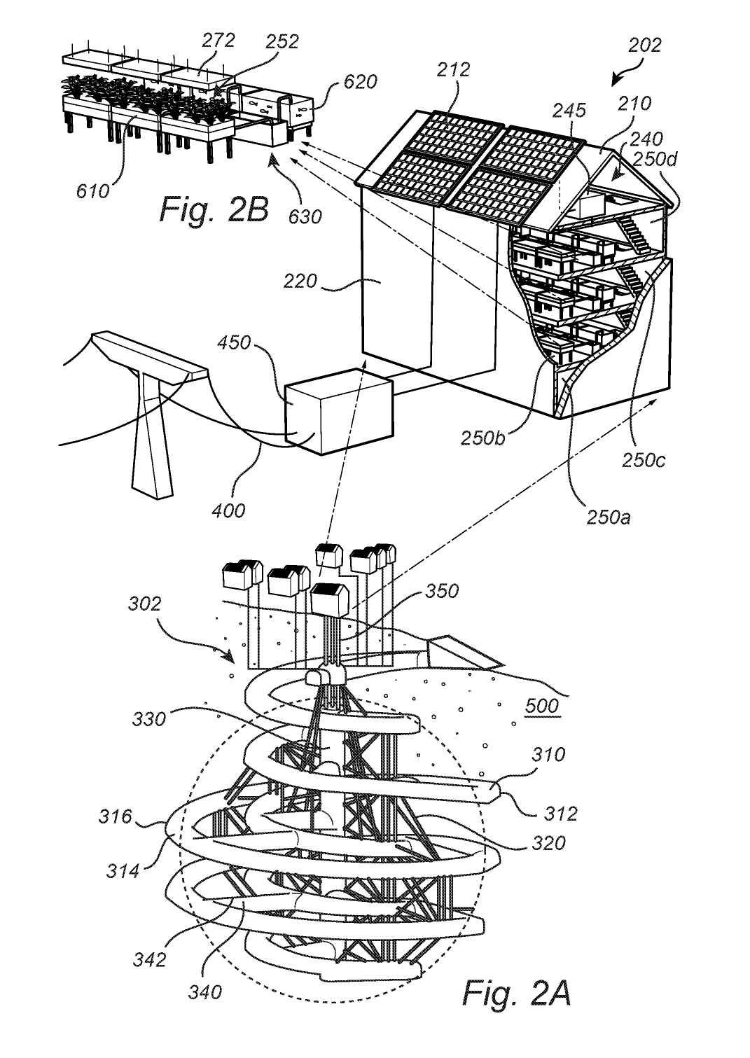

The subterranean thermal energy storage 300 may comprise at least one channel having cross-sectional area being smaller than a cross-sectional area of the tunnel, the channel being formed in the subterranean medium. In one embodiment the subterranean thermal energy storage 300 comprises at least one shaft and/or at least one chamber. The subterranean thermal energy storage will be further described in connection to FIG. 2a.

The structure 200 may comprise a plurality of climate zones, the climate zones having different temperatures. In the embodiment of FIG. 1, one climate zone may be arranged to extend along a sub-area 262. In order to create such a climate zone, at least one wall may be arranged to delimit or define the climate zone. The at least one wall may be arranged to extend along the sub-area 262.

The heater-cooler unit 280 may be arranged to retrieve water from the air of the structure 200 by transforming vapor in the air of the structure 200 into water. In e.g. greenhouses, it is preferable to have a relative atmospheric humidity of about 80%, and below about 90%. The relative atmospheric humidity may be adapted to the type of plants grown in the structure. The cultivation structure may comprise measuring units arranged to measure humidity may. The measuring units may be connected to a control system of the heating-cooling system. Water in air comes from both irrigation and transpiration of and evaporation from the plants. The temperature and humidity of the surrounding air influences the transpiration of the plants.

If the air is cooled, it comprises less moisture. Heat that is retrieved, when retrieving water from the air, may be transported to the subterranean thermal energy storage, to the district heating system and/or sold to other households.

The cooler unit 290 may be arranged to retrieve water from the air in the attic 240 by transforming vapor in the air into water. The external cooler unit 295 may be arranged to retrieve water from the air outside the structure 200 by transforming vapor in the air surrounding the structure 200 into water.

The structure 200 may comprise an irrigation system arranged to irrigate the area for cultivation 260. The irrigation system may be connected to the heating-cooling system and arranged to transport retrieved water from the heating-cooling system to the area for cultivation 260. The irrigation system may be connected to a rain collector (not shown) arranged to retrieve water from rain. The retrieved water may be nearly as clean as distilled water. If the amount of retrieved water is more than the amount required by the irrigation system, the excess water may be transported from the arrangement. Optionally, the excess water may be sold to other households. The arrangement may then include a purification device for cleaning the water from, e.g., algae, dust, and particles.

In one embodiment, the irrigation system comprises a plurality of nozzles that may be arranged in the structure and arranged to irrigate the cultivation area. Water may be sprayed out from the nozzles. In one embodiment, the air in the structure may be heated and/or cooled by the spraying water sprayed out from the nozzles. The amount of water that is to be emitted from the nozzles preferably comprises the amount of water that is needed for irrigation and an additional amount for the heating and/or cooling. As the nozzles provide heat and/or cold, the nozzles may also be included in the heating-cooling system.

FIG. 2a illustrates an embodiment of the inventive cultivation structure. In the arrangement 102, the structure 202 is an opaque building with roof 210 and walls 220 that may be insulated. A plurality of solar cells 212 are arranged on the roof 210 and the plurality of solar cells 212 may be transparent or at least partly transparent. Hence, sun light may be let into the structure through the solar cells 212.

The structure 102 comprises an attic 240 and a plurality of floors 250a-d. The plurality of floors 250a-d each comprise an area 252 for cultivation.

Thus, within the structure, cultivation may be performed at a plurality of levels, increasing the growth area. At least one heater-cooler unit may be arranged on each floor and the heater-cooler units may be connected in series.

The structure 200 may comprise a plurality of climate zones, the climate zones having different temperatures. In the embodiment of FIG. 2a, each floor may have a different climate zone.

A plurality of LED:s 272 (illustrated in FIG. 2b) are arranged to illuminate the areas 252 for cultivation. The plurality of LED:s 272 may e.g. be arranged over the areas for cultivation.

The solar cells 212 may be arranged to supply the plurality of LED:s 272 with power. In one embodiment, the solar cells are arranged to, at least partly, supply the plurality of LED:s with power. The solar cells are arranged to convert the energy of solar light into electricity. In one embodiment, the solar cells are directly connected to the LED:s through a transformer. It may be advantageous to instead connect the solar cells to the grid 400 and also connect the LED:s to the grid 400. In this way, excess electricity may be used elsewhere. A transformer 450 may be arranged between the grid and the arrangement.

The arrangement 102 further comprises a cooler unit 245 corresponding to the cooler unit 245 of FIG. 1 and at least one heater-cooler unit (not shown) corresponding to the heater-cooler unit 280 of FIG. 1. In one embodiment, a heater-cooler unit is arranged on each floor 250a-d.

A cooling liquid may be retrieved from the subterranean thermal energy storage and transported to the bottom floors, which may also be referred to as lower levels. The liquid may be circulated in pipes and heat may be exchanged with surrounding air. The cooling liquid may successively be transferred upwards in the structure. After having been circulated in the structure, e.g. via a heater-cooler unit and/or a cooler unit, a temperature of the liquid may be up to 70 to 100° C. This thermal energy may then be transmitted to the subterranean thermal energy storage and be utilized at another time or for other purposes. The temperature range of about 70 to 100° C. corresponds to the temperature of district heating. Thus, a heat pump is not necessary in order to arriving at such temperatures.

The structure 202 may comprise an irrigation system arranged to irrigate the areas for cultivation. The irrigation system may be connected to the heater-cooler unit and/or the cooler unit and arranged to transport retrieved water from the heater-cooler unit and/or the cooler unit to the areas for cultivation. The irrigation system may be connected to a rain collector (not shown) arranged to retrieve water from rain. The retrieved water is nearly as clean as distilled water. If the amount of retrieved water is more than the amount required by the irrigation system, the excess water may be transported from the arrangement. Optionally, the excess water may be sold to other households. The arrangement may then include a purification device for cleaning the water from, e.g., algae, dust, and particles.

In one embodiment, the irrigation system comprises a plurality of nozzles that may be arranged in the structure and arranged to irrigate the cultivation area. The water may be sprayed out from the nozzles.

In one embodiment, the air in the structure may be heated and/or cooled by the spraying water. The amount of water that is to be emitted from the nozzles preferably comprises the amount of water that is needed for irrigation and an additional amount for the heating and/or cooling.

The cooler unit and the at least one heater-cooler unit are connected to a subterranean thermal energy storage 302.

The subterranean thermal energy storage 302 is formed in a subterranean medium 500, or ground, such as e.g. rock, bedrock, soil. The subterranean thermal energy storage 302 comprises a first subterranean tunnel 310 having a tunnel wall 312, the first subterranean tunnel 310 and the tunnel wall 312 being formed in the subterranean medium 500. The subterranean thermal energy storage 302 may comprise a second subterranean tunnel 314 having a tunnel wall 316, the second subterranean tunnel 314 and the tunnel wall 316 being formed in the subterranean medium 500.

Each tunnel 310, 314 may extend at least partially along a respective circular arc. Each tunnel 310, 314 may be configured as a helix, the two tunnels 310, 314 forming an inner helix 310 and an outer helix 314, wherein the outer helix 314 is arranged around the inner helix 310. The first subterranean tunnel 310 may be an inner tunnel and, the second subterranean tunnel 314 may be an outer tunnel.

The first subterranean tunnel 310 and the second subterranean tunnel 314 may be connected to each other by at least one passage 340 such that fluid communication is allowed between the tunnels. The at least one passage 340 may have a passage wall 342, the at least one passage 340 and the passage wall 342 being formed in the subterranean medium. A cross-section of the passage is of approximately the same size as cross-sections of the tunnels 310, 314.

The tunnels 310, 314 may be arranged to store a fluid, e.g. water.

The subterranean thermal energy storage 302 comprises a plurality of channels 320, the channels 320 having cross-sectional areas being smaller than a cross-sectional area of the tunnels. The channels 320 are formed in the subterranean medium 500. The channels 320 may connect the tunnels, different elevations of tunnels, and/or the passages (described further below). The channels may be arranged in a tight pattern in between the tunnels.

In one embodiment, the subterranean thermal energy storage 302 comprises at least one shaft 330 and/or at least one chamber (not shown). The tunnels 310, 314 may be connected to the shaft 330 by a plurality passages such that fluid communication is allowed between the tunnels and the shaft.

The subterranean thermal energy storage 302 may comprise at least one fluid communication means 350 arranged to extract an arbitrary portion of said fluid from the tunnels and/or shaft at a suitable vertical level so as to allow processing of said fluid, e.g. in the structure and/or in connection to the structure, wherein said fluid communication means further is arranged to return processed fluid to the tunnels and/or shaft at a suitable vertical level. The at least one fluid communication means may be part of the circulation system.

During use of the subterranean thermal energy storage, a fluid is circulated in the channels, tunnels, passages, and/or shaft and thermal energy is stored. Furthermore, thermal energy is stored in the subterranean medium in between the channels, tunnels, passages, and/or shaft.

In one embodiment, the middle section of the subterranean thermal energy storage has larger dimensions than at least one end section of the subterranean thermal energy storage, as seen in the direction of its centre axis. When both end sections of the subterranean thermal energy storage are smaller than the middle section, the storage has an essentially spherical shape. The use of such a generally spherical shape, comprising both tunnels and the intermediate ground, minimizes the peripheral area of the storage and hence the heat loss, while still achieving an as large volume within the periphery of the storage as possible. When only one end section is smaller, then the shape essentially corresponds to a cone or a pyramid, as seen in the direction of the centre axis of storage.

This kind of energy storage can be used for storage of hot fluid, e.g. up to 95° C., and cold fluid, e.g. down to 4° C., as well as fluid having an intermediate temperature. Intermediate temperature means a temperature which is significantly lower than the hottest fluid which can be stored, but which is higher than the coldest fluid which can be stored, as well. Intermediate temperature fluid may be used, e.g., in low temperature systems. The heat exchange to the low temperature systems may be performed without using any heat exchangers. Instead, the fluid of intermediate temperature may be circulated in the low temperature systems. Fluid having an intermediate temperature of for example 40-70° C. is usually a fluid being returned back into the storage after heat exchange to a district heating system.

When storing thermal energy in the ground, layering occurs in the storage, if the storage space has a sufficiently large volume, due to the differences in density between volumes of fluid having different temperatures. The warmer the fluid, the higher up in the storage it is located.

When charging the storage with hot fluid, cold fluid from a lower layer of fluid is circulated up through the storage and past a heat exchanger where it is heated. The heat exchanger may be the at least one heater-cooler unit and/or any one of the cooler units. Thereafter it is supplied to the layer of fluid in the storage which has the corresponding, higher temperature. The process is reversed during discharge, i.e. hot fluid from an upper layer is circulated to the heat exchanger where it releases its energy where after it is returned to the layer of storage which has the corresponding, lower temperature.

When charging the storage with cold fluid, hot fluid from a higher layer of fluid is circulated up through the storage and past a heat exchanger where it is cooled off. The heat exchanger may be the at least one heater-cooler unit. Thereafter it is supplied to the layer of fluid in the storage which has the corresponding, lower temperature. The process is reversed during discharge, i.e. cold fluid from a lower layer is circulated to the heat exchanger where it absorbs energy where after it is returned to the layer of storage which has the corresponding, higher temperature.

The fluid used in the storage is preferably water, but could be, e.g., a mixture of water and a coolant, any liquid fuels such as hydro carbons of fossil origin or biological origin (bio fuel), a salt solution, ammonia, or other refrigerants.

The process equipment connected to the storage is arranged in a processing area, and comprises among other things heat exchangers and pumps.

The storage can be used both for heating, i.e. the fluid which is returned to the storage has a lower temperature than when it was extracted, and for cooling, i.e. the fluid which is returned to the storage has a higher temperature than when it was extracted.

As is illustrated in FIG. 2b, the area for cultivation may comprise a hydroculture system 610. Thus, the plants may be grown in a soilless medium, or an aquatic based environment. Plant nutrients may be distributed via water. Water and nutrients may be distributed through capillary action or by some form of pumping mechanism. The roots may be anchored in clay aggregate. The irrigation system may include said pumping mechanism and/or pipes for providing said capillary action.

As is illustrated in FIG. 2b, the area for cultivation may be connected to an aquaculture 620. The aquaculture may comprise farming of aquatic organisms such as fish, crustaceans, mollusks, and aquatic plants. Combining the hydroculture system 610, which may also be referred to as a hydroponic system, with the aquaculture 620, an aquaponic system 630 is obtained. Thus, the arrangement may comprise an aquaponic system.

Water from an aquaculture may be fed to the hydroculture system. The the by-products may be broken down by nitrification bacteria into nitrates and nitrites, which are utilized by the plants as nutrients. The water may then be then recirculated back to the aquaculture system.

In one embodiment, a farm may be arranged in connection to the structure or in the structure. The farm may comprise animals that may provide manure that may be used in the area for cultivation.

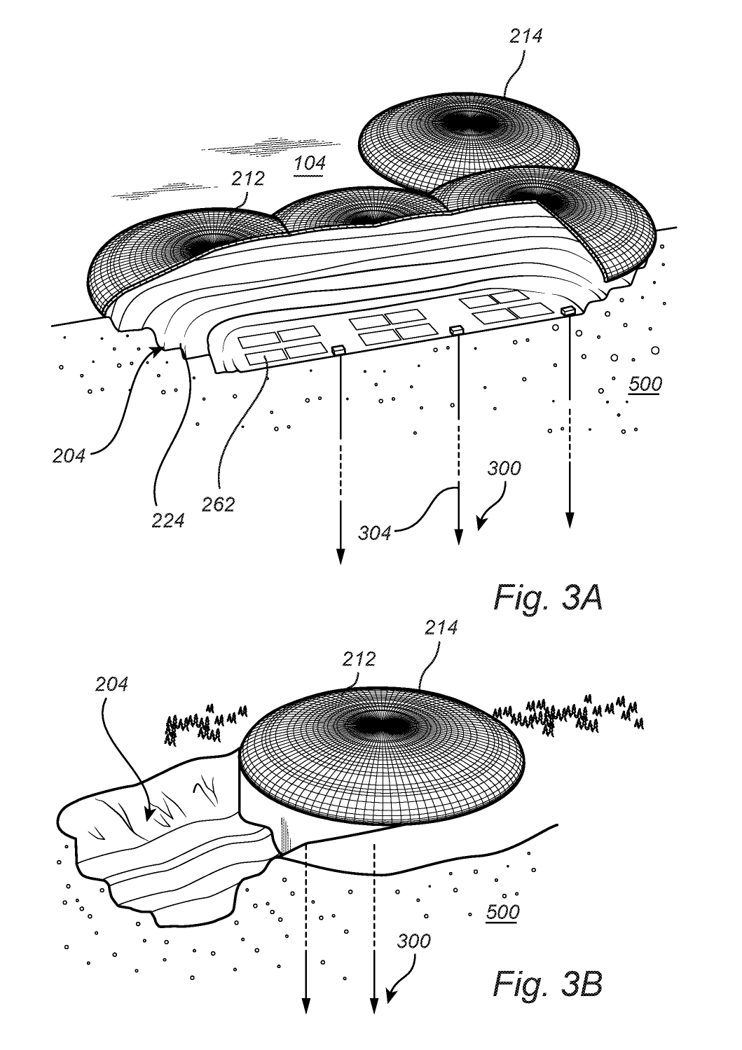

FIGS. 3A and B area perspective views of a embodiments of the inventive arrangement. In this arrangement 104, the structure 204 is a covered pit. The pit may be an open ground pit such as an abandoned quarry or similar. A roof 214 is arranged on the pit. The natural pit surfaces may constitute walls and floors of the structure 204. Thus, the walls 224 and floors may be made of stone. The roof 214 of the pit may be transparent in order to let sun light into the pit. In one embodiment, the roof is transparent/semi-transparent solar cells. In this embodiment, solar cells 212 are arranged in connection to the structure 204, at a ground level.

The structure 204 comprises an area for cultivation 262. The arrangement may comprise all or some of the features described in connection to FIGS. 1-2.

A difference between FIGS. 3A and B is that in FIG. 3B, a part of the pit constitutes the structure. A wall of the structure is not a natural pit surface but has instead been mounted.

The vertical temperature gradient in a deep/high volume, such as inside the structure 204, may be 0.7 to 1.0 centigrades per meter. At a height of 100 m the temperature difference can thus be as large as 70 to 100° C. A structure utilizing natural materials, such as e.g. stone, as climate shell will have a lower heat resistance than an insulated opaque structure. However, since natural walls and floors have a large heat capacity, acting as subterranean thermal energy storage, the need for active heating/cooling is reduced.

The structure is connected to a subterranean thermal energy storage 304 which may correspond to the subterranean thermal energy storages 300 and/or 302 described in connection to FIGS. 1 and 2. Furthermore, the arrangement 104 may also comprise at least one heater-cooler unit and/or at least one cooler unit corresponding to the units described in connection to FIGS. 1 and 2.

In one embodiment (not shown), the structure is a tunnel or a part of a tunnel. In this embodiment, no sun light is let into the structure. If the structure is a part of a tunnel, walls may have been arranged in the tunnel. The arrangement may comprise all or some of the features described in connection to FIGS. 1-3.

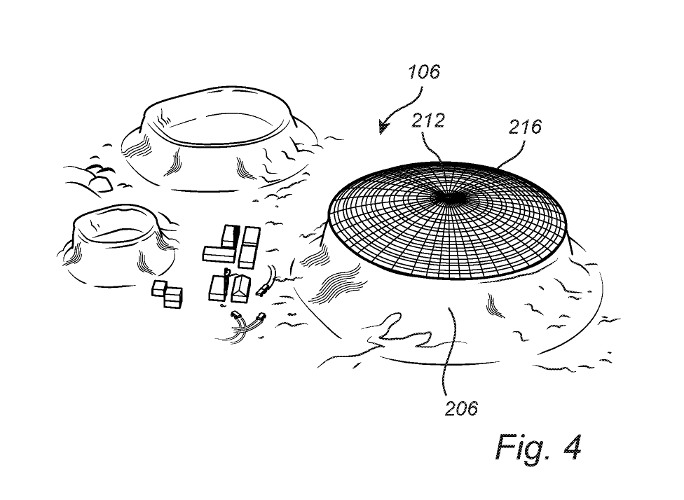

As is illustrated in FIG. 4, the arrangement 106 may be arranged on a planet other than earth, a moon, an asteroid, a comet, and/or a space station. The structure 206 may be an extraterrestrial covered crater. As is illustrated, solar cells 212 may be arranged in connection to the structure 206. In this embodiment, the roof 216 of the structure is dome shaped. A subterranean thermal energy storage may be arranged in connection to the structure 206 and connected to the structure. In one embodiment, the structure 206 comprises at least one cavity formed in a subterranean medium in which people and animal may live. Since a roof of the cavity may be formed in the subterranean medium. This is advantageous in that it provides a protection against incoming objects. As an example, a meteorite may fall on the roof 216 of the structure 206 which may result in the roof 216 breaking.

In one embodiment, the opaque structure may be arranged in a desert in Sahara, where the day is relatively short, but plants may be cultivated which usually are used to the midnight sun.

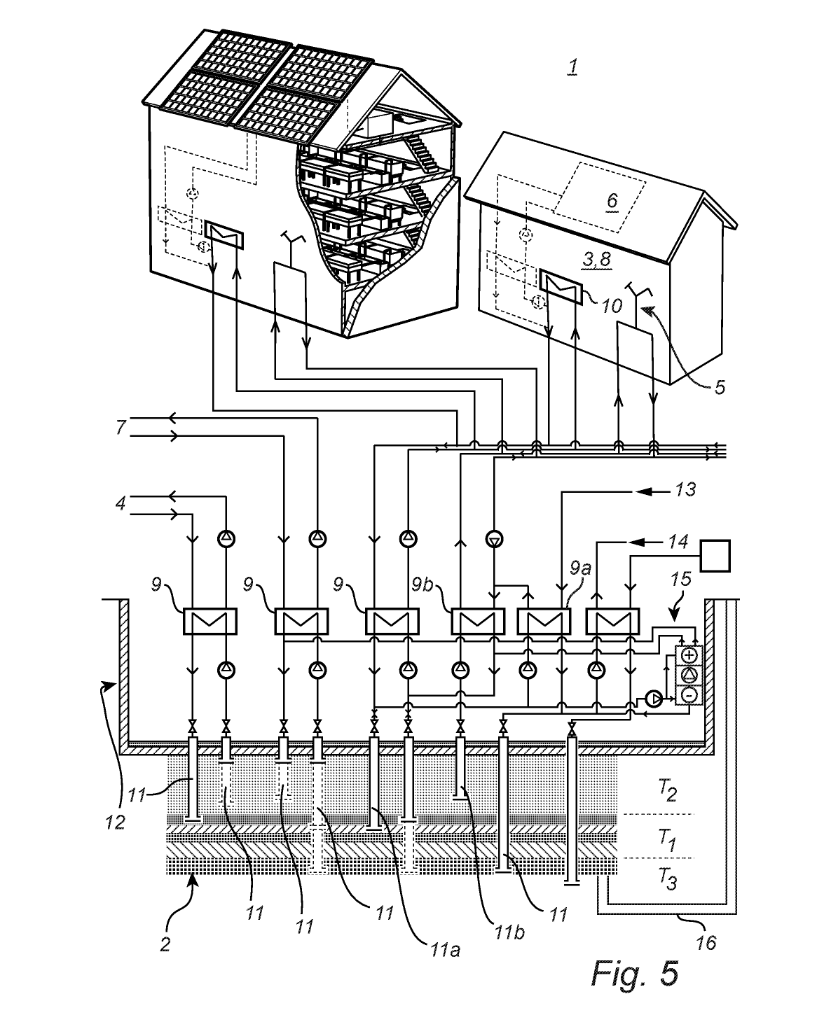

FIG. 5 schematically illustrates an embodiment of the inventive arrangement 1. A subterranean thermal energy storage 2, which may be a tank, an underground cavern, or a subterranean thermal energy storage designed for high performance on input/output of energy and a large seasonal storage capacity, is illustrated.

In the energy storage 2, energy of different temperatures may be stored. The upper layers of the energy storage have higher temperatures than the cooler, lower layers. There are also layers having intermediate temperatures in the transition zone there between. The temperatures within the layers of the energy storage can be defined as temperature intervals T₁, T₂, and T₃. These intervals may be adapted to any specific working conditions. As a mere example, the first temperature interval T₁ may be within the range of 15° C. to 65° C., the second temperature interval T₂ may be within the range of 50° C. to 100° C., and the third temperature interval T₃ may be within the range of 4° C. to 25° C. The temperatures in interval T₂ may be higher during periods of time, for example up to 150° C.

The layering within the energy storage 2 is due to the differences in density between fluid, i.e. liquid water, having different temperatures. Warm liquid water has a lower density than cooler water in the range above 4° C., which causes water of different temperatures to be placed at different vertical levels within the energy storage, i.e. vertical temperature stratification. The difference in densities generates a gradient flow during the extraction of heat from the energy storage as warm water, having a lower density, flows upwards through the storage to a heat exchanger where it is cooled down. In a return pipe, the difference in densities generates a downward flow of colder water. This results in two water pillars of different density causing a gravitational force, which can be used for gradient flow, in order to reduce the consumption of electrical energy. While charging the energy storage with heat the effect is reversed, and an additional electrical energy source such as a pump or a motor has to be added to drive the flow.

Since charging of the energy storage is mainly performed during the summer while discharging is mainly performed during the winter, this implies that additional electric energy is needed for pumping during the summer but may be generated during the winter, when the demand and cost is higher, i.e. seasonal storage of electric energy. The additional electrical energy will be supplied by a pump with an electrical motor in the summer. The same pump-electrical motor will be used as a turbine-electrical generator during the winter. A large vertical height of the energy storage will increase this effect.

In order to use the full potential of the storage, it is advantageous to use the different, available temperatures effectively. One condition is that the storage is provided with inlets and outlets at different heights. Hence, there are a number of fluid communication means 11, e.g. telescopic pipes, which run from a processing area, and which are arranged to retrieve a portion of the fluid from the energy storage at a suitable vertical level of the energy storage so as to allow processing of the fluid by means of at least one heat exchanger 9. The fluid communication means are further arranged to return the processed fluid to the energy storage at a suitable vertical level of the energy storage.

The energy storage 2 may be connected to a heat-absorbing system 3, 4, and/or a heat-emitting system 7 via heat exchangers 9. The heat-absorbing system 3 may be a structure as described in connection to any one of FIGS. 1-4. The structure of FIG. 2a is illustrated in FIG. 5 and connected to the energy storage. In one embodiment, T₁ may be within the range of 31° C. to 16° C., T₂ may be within the range of 60° C. to 40° C., and T₃ may be within the range of 20° C. to 4° C.

As an example, a heat-absorbing system 3 can be a low temperature system such as a heating system for heating of buildings. The first heat-absorbing system 3 is connected to a heat exchanger 10. Energy of a first temperature, e.g. from temperature interval T₁, is retrieved from the energy storage 2 and is used for heating buildings using the heat exchanger 10. The heat-absorbing system 3 can also be used as a heat-emitting system, collecting heat from the consumers in the system.

Another example of a heat-absorbing system 4 is a high temperature system, preferably a district heating system. The heat-absorbing system 4 can be charged with energy having a temperature within interval T₂ taken from the energy storage 2, or with energy having a temperature within interval T₂ taken directly from an internal combined heating and cooling machine 15. The internal combined heating and cooling machine 15 is discussed in more detail below. The heat-absorbing system 4 can also be used as a heat-emitting system, collecting heat from the consumers in the system.

The term energy may here be interpreted as a fluid or liquid having a thermal energy and/or temperature.

The heat-emitting system 7 provides energy which may be produced by an industrial facility or other sources of waste heat, a combined heat and power plant (CHP), solar panels for electrical generation and/or heating, a heat pump, a bio fuel boiler, an electrical hot water boiler and/or an electrical steam boiler, or a fossil fuel boiler. For the use as arrangements for regulating of the electrical grid, the combined heat and power plant and the electrical hot water boiler and/or electrical steam boiler are highly preferred arrangements.

A combined heat and power plant (CHP) arranged in the heat-emitting system 7 generates both heat and power, typically in a ratio of 2:1 for large scale plants. During periods when the price for electricity is low, an energy production without electrical generation may be preferred. The entire boiler capacity is at this point generated as heat, i.e. 150% of the normal heat generation. If the combined heat and power plant is advanced, the ratio may be 1:1 and the boiler capacity 200%. However, the condenser in the plant and some additional equipment such as a steam transformer (for transforming superheated steam into saturated steam) is required within the plant. In combination with the energy storage 2, the turbine can be connected to the electrical grid by a synchronic generator and be operated without electrical generation during day time, delivering only heat to the energy storage. If required during night, the combined heat and power plant can generate also electricity at full power (wind/solar compensation). The addition of a combined heat and power plant, operated in combination with a subterranean thermal energy storage as described above, means that a rotating mass is included in the system which compensates for grid variations within seconds.

An electrical hot water boiler and/or an electrical steam boiler arranged in the heat-emitting system 7 may be used for peak shaving of electrical surplus energy, for example for consuming electricity during daytime (wind/solar peak-shaving).

The above mentioned combined heat and power plant and electrical hot water boiler and/or an electrical steam boiler may be either a new arrangement or an already existing arrangement.

The system further comprises an internal heating and cooling machine 15, which is connected to the energy storage 2. In one aspect, the system is used in order to increase the energy storage capacity of the energy storage 2 for heating and cooling purposes. In another aspect, the system is used for increasing the heating capacity of the storage.

Preferably, the internal heating and cooling machine 15 comprises at least two heat pumps. The internal heating and cooling machine 15 is connected to the energy storage 2 by fluid communication means 11 in the same way as described above.

As one example, the internal heating and cooling machine 15 retrieves fluid from one level of the temperature interval T₁ from the energy storage, while simultaneously returning heated fluid having a higher temperature to the interval T₂ and cooled fluid having a lower temperature to the interval T₃, to the corresponding level in the energy storage or e.g. directly to the heat-absorbing system 4. Fluid could however also be retrieved from one level of the temperature interval T₁ and returned to a warmer, i.e. upper, level of the same temperature interval T₁ and a cooler, i.e. lower level of the same temperature interval T₁. Hence, the heated and cooled fluid can be returned to any fluid layer within the energy storage being arranged above and below the level where fluid is retrieved, i.e. at levels having higher and lower temperatures.

As mentioned above, the internal heating and cooling machine 15 comprises at least two heat pumps. Each heat pump comprises at least two compressors, which can be are connected both in series and in parallel on the refrigerant side of the heat pump. The number of heat pumps and the number of compressors within each heat pump can however be any suitable number. The larger the number of heat pumps/compressors, the more efficient the internal heating and cooling machine 15 is. This must however be weighed against the increase in costs that an increase in number of components leads to.

The internal heating and cooling machine 15 retrieves fluid from a first level of the energy storage within temperature interval T₁ from, e.g. an intermediate temperature level. The heat pumps are used for simultaneously converting this energy into energy for both heating and cooling purposes. The energy for heating and cooling is returned to the correct, corresponding temperature levels in the energy storage or e.g. transmitted directly into a heat-absorbing system 4 such as a district heating system. Each heat pump may use a different refrigerant. In order to achieve a maximum coefficient of performance (COP), the flow over the water side of the evaporators, condensers, and sub-coolers will be arranged in series in order to reduce the needed temperature lift across each heat pump.

In one embodiment, the internal combined heating and cooling machine is directly connected to the solar cells through a transformer. It may be advantageous to instead connect the solar cells to the grid and also connect the internal combined heating and cooling machine to the grid. In this way, excess electricity may be used elsewhere.

In a first example, the first and second heat pumps each comprise at least two compressors connected in series. Serial connection is preferably used when the price of electricity is low. In this example, the heat pumps will generate energy for the upper temperature interval T₂ (95° C.) and for the lower temperature interval of T₃ (5° C.), using energy from temperatures interval T₁ (45° C.). A coefficient of performance COP for heating of 3-4 is achieved. When the cooling effect is included, the COP is 5-6. The actual value depends on the number of heat pumps, the number of compressors, and the efficiency of the system.

In a second example, the first and second heat pumps each comprise at least two compressors connected in parallel. Parallel connection is preferably used when the price of electricity is relatively high. In this example, the heat pumps will generate energy for the upper temperature interval T₂ (90-95° C.) and for the intermediate temperature interval T₁ (40° C.), using energy from the upper level of temperature interval T₁ or the lower level of temperature interval T₂ (65° C.). A COP for heating and cooling which is approximately three times higher than the COP for compressors connected in series is achieved. The actual value depends on the number of heat pumps, the number of compressors, and the efficiency of the system.

In a third example, the first and second heat pumps also comprise at least two compressors each, connected in parallel. In this example, the heat pumps will generate energy for the intermediate temperature interval T₁ (55° C.) and for the lower temperature interval T₃ (5° C.), using energy from the upper level of temperature interval T₃ or the lower level of temperature interval T₁ (20° C.). A COP for heating and cooling which is approximately three times higher than the COP for compressors connected in series is achieved. The actual value depends on the number of heat pumps, the number of compressors, and the efficiency of the system.

The parallel connection according to the second example illustrates how energy at an intermediate temperature level can be transformed into high temperatures corresponding to conventional district heating levels and simultaneously generate energy at temperatures corresponding to a low temperature system. In the third example, the same equipment can extract energy from the energy storage at a lower level in order to optimize the production of cooling energy at the 5° C. temperature level and for producing temperatures for a low temperature system.

One advantage of the above described subterranean thermal energy storage system is hence the possibility of optimizing the storage of energy by choosing at which temperature levels the energy is to be retrieved and released, all depending on the specific conditions in the grid and in the energy storage at a given period in time.

The alternative operation of the compressors having both series and parallel connection may require different sizes of the compressors, corresponding to the number of compressor units operating in series. In this arrangement the compressors can be connected to one common motor. Alternatively, the compressors may be of the same size but will, in series connection, require a speed regulation between the compressor and the motor. Different arrangements can be used for that purpose, such as mechanical gears or frequency regulation of electrical motors. Use of hydraulic motors or steam turbines is possible instead of electrical motors.

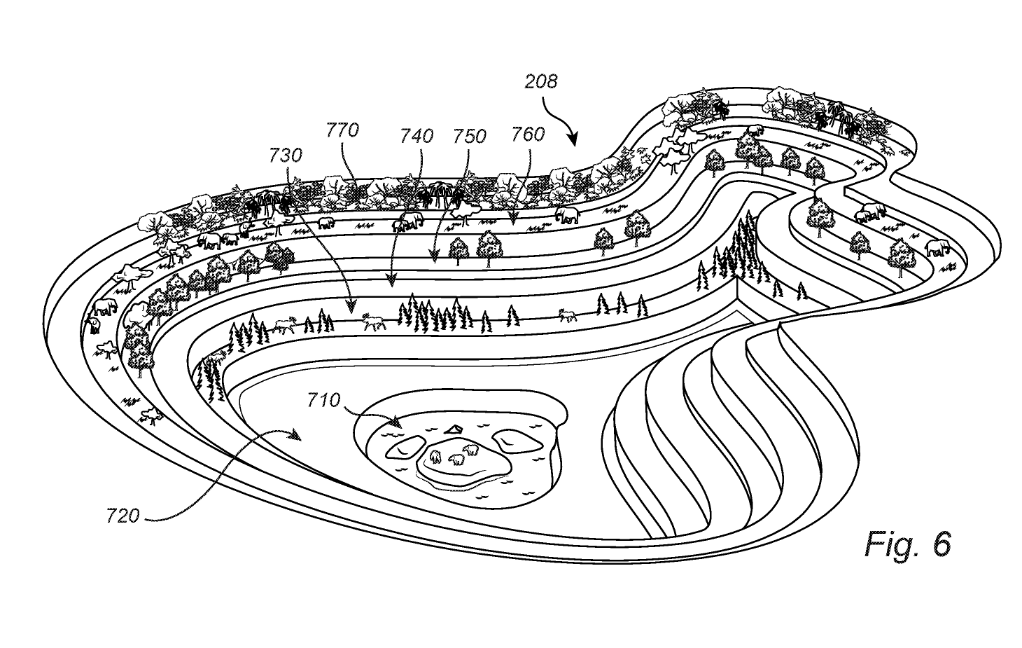

FIG. 6 illustrates an embodiment of the inventive structure. The inventive structure may be combined with any one of the subterranean thermal energy storages of FIGS. 1-5. The structure 208 may have a roof which is not shown for simplicity reasons. Solar cells may be arranged in connection to the structure.

The structure 208 comprises a plurality of levels having different climate zones, the climate zones having different temperatures and different air humidity. Climate zones in the lower levels of the structure have lower temperatures and air humidity. The higher up in the structure a climate zone is, the higher is the temperature and the air humidity. The lowermost climate zone 710 has a polar climate. In the climate zone 710 water may freeze to ice and polar bears may live. The climate zone 770 has a tropical climate and comprises a rain forest.

The plurality of climate zones arise from thermal convection. Heat and moist travel upwards, in a direction towards the roof of the structure. The structure may also comprise a heating-cooling system arranged to provide heat and/or cold in order to adjust the temperatures of the climate zones. In one embodiment, the structure comprises an apparatus for creating ice so that an ice ring may be created in the polar zone. Even though only animals are illustrated, people may also be in the structure. The structure may, e.g. be a zoological garden which may be visited by people. The animals may be locked up in cages or by fences.

LED:s may be arranged to illuminate the plurality of climate zones. The LED:s may be arranged on light fittings. In one embodiment, the LED:s are included in street lighting arranged on the plurality of levels.

It is noted that this embodiment may be combined with any one of the other embodiments described herein.

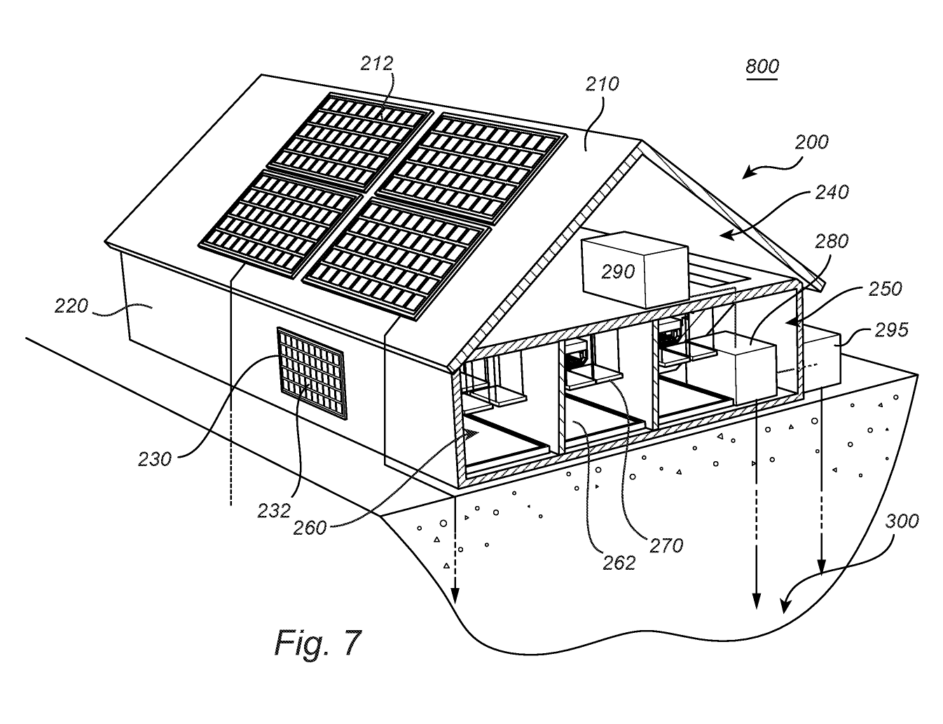

FIG. 7 illustrates an embodiment of the inventive arrangement in FIG. 1 with a difference. In the structure of the arrangement 800, horizontal climate zones have been provided. Walls have been arranged extended along area for cultivation 262. The air in the room having area 262 may have a different temperature and air moisture than the rest of the structure. As an example, more moisture and/or heat may be provided using the nozzles.

It is to be understood that horizontal climate zones may be arranged in all the structures described herein. Walls may be arranged in the structures in order to delimit the climate zones.

Other variations to the disclosed embodiments can be understood and effected by those skilled in the art in practicing the claimed invention, from a study of the drawings, the disclosure, and the appended claims. As an example, the subterranean thermal energy storages described herein are interchangeable in the embodiments. All embodiments described herein may be combined.

In order to increase the amount of light illuminating the area for cultivation, the structure may comprise means for directing reflected light towards the area for cultivation. Surfaces inside the structure such as ceiling, walls, floors and interior may have reflective surfaces such as mirrors, reflecting materials, and/or reflective coatings. The surfaces may also have fluorescent coatings.

The structure may be opaque. In one embodiment, the opaque structure may be a building having an insulated roof, walls and windows. The windows may be transparent or semitransparent solar cells. In another embodiment, sun light is not let into the structure, instead, the lighting is all artificial by use of LED:s. In yet another embodiment, the structure is a greenhouse.

In another embodiment, the structure is combined with residential and/or commercial areas. As an example, the structure may be arranged inside residential and/or commercial areas. In another example, the structure is arranged to at least partly enclose the residential and/or commercial areas. In the latter embodiment, the structure is at least partly transparent.

The structure may comprise a plurality of sub-areas for cultivation, the sub-areas being arranged at a plurality of horizontal levels in the structure. LED:s may be arranged to illuminate the sub-areas. The different levels may be arranged according to temperature. Temperatures may be controlled to be at a preferable level for different cycles of growth. Effect of vertical stratification may be utilized. Humidity may be controlled to be at a preferable level for different cycles of growth. The heating-cooling system may comprise a control system arranged to control the indoor climate. Controlling the indoor climate of the cultivation structure may comprise controlling at least one of temperature, light, carbon dioxide and humidity. In particular, controlling the indoor climate of the cultivation structure may comprise controlling at least one of level of temperature, amount and/or wavelength of light, percentage of carbon dioxide and humidity. The control system may comprise a plurality of measuring units. The measuring units may be arranged to measure at least one of temperature, humidity, carbon dioxide and light. The measuring units may be dedicated to measuring one quantity, such as e.g. temperature, or may be arranged measure a plurality if quantities such as e.g. temperature, humidity and light. The measuring units may be arranged to measure a temperature of air in the structure, a temperature of air outside the structure, and a temperature of what is cultivated.

The LED:s may be chosen so that they have suitable wavelengths and wavelengths that are not so effective may be excluded. As an example, blue light (400-490 nm) and red light (about 600-690 nm) is very advantageous when it comes to cultivation and increases the growth ratio. It is advantageous for the photosynthesis if a plant is illuminated with light of a wavelength in the range of about 600-690 (red light), and/or light of a wavelength in the range of about 400-490 (blue light). Using LED:s for illuminating plants one may prolong the day and, also, the growing season may be prolonged. Yellow light has a lower effect on the photosynthesis however, at least one of the LED:s may emit yellow and/or white light since it is pleasant for human beings being in the structure. In order to maximize the desired wavelengths, at least a part of the inside of the structure may be provided with a fluorescent coating.

At surrounding temperatures of above 25° C., the lifetime of LED:s is substantially reduced. The lower temperature that the LED:s are exposed to, the longer the lifetime. Therefore, the arrangement and method are very advantageous since the temperature of the air in the structure may be adapted to such conditions. Furthermore, and as is mentioned herein, it is advantageous in cultivation to keep the temperature of the air below 25° C.

The amount of LED:s may be adapted to how large part of the structure is transparent. The more opaque the structure is, the more LED:s are needed.

The solar cells may be photo voltaic (PV). The solar cells may be arranged such that a space is created between the solar cells and the structural parts that they are attached to. This space may be used for cooling the solar cells and for retrieving heat produced by the solar cells. The solar cells may be arranged such that an attic is formed between the solar cells and the structure which may also be used for cooling the solar cells and for retrieving heat. The solar cells produce heat during use. The produced heat may be transported to the subterranean thermal energy storage.

At least one cooler unit may be installed in the space/attic in order to retrieve heat and transport the heat to the subterranean thermal energy storage. The cooler unit may also be arranged to cool solar cells arranged on top of the structure. Cooling solar cells increases the PV electrical efficiency. The cooler unit may be supplied with cooling water of intermediate temperature or lower (8-18° C.). At some conditions cooling results in condensation of outdoor air. This water, together with rain water, is collected and used by the irrigation system. Any excess water may be used for other purposes than irrigation. The arrangement may then include a purification device for cleaning the water from, e.g., algae, dust, and particles. The heated cooling water is then returned to the subterranean thermal energy storage and may be exported as heat via district heating network (4) or low temperature system (9) or warm water system (9b).

The solar cells may be arranged on top of the structure, either on the roof or forming the roof. Additionally, or alternatively, the solar cells may be arranged on a rack or on the ground next to the structure or at a distance from the structure. Alternatively, the solar cells may be arranged on top of another structure.

The solar cells may be semitransparent. In one embodiment, the solar cells are transparent to visible light but opaque to other wavelengths and use the light of the other wavelengths for producing electricity.

The arrangement 100 comprises a heater-cooler unit 150 in the structure and a subterranean thermal energy storage 200 connected to the heater-cooler unit. The heater-cooler unit 150 is arranged to cool air in the structure by transporting heat from the air in the structure 120 into the subterranean thermal energy storage. This may be performed by retrieving cooling liquid, e.g. water, the subterranean thermal energy storage. The cooling liquid may, e.g., have a temperature of about 8° C. It is to be noted that also other temperatures are possible. The cooling liquid is then circulated in the structure and indirectly heated by the air. The heated cooling liquid is transported back to the subterranean thermal energy storage. The heated cooling liquid may, e.g., have a temperature of about 18° C. It is however to be noted that also other temperatures are possible.

In one embodiment, the cooling liquid is transported to the attic of the structure after having been heated by the air in the structure. In the attic, the cooling liquid is further heated by, e.g., heat from the solar cells, and/or solar heat transmitted through solar cells and/or windows.

The at least one heater-cooler unit may be arranged to heat the air in the structure by transporting heat from the subterranean thermal energy storage into the structure. Excess heat may be transported from the arrangement. Optionally, the excess heat may be sold to other households.

The at least one heater-cooler unit may be arranged to cool the air in the structure by transporting heat from the structure into the subterranean thermal energy storage.

The cooler unit may be arranged to cool the air in the structure by transporting heat from the structure into the subterranean thermal energy storage.

The cooler units and the at least one heater-cooler unit may be similar but used for different purposes. The cooler units may comprise cooling batteries and the at least one heater-cooler unit may be a heating battery and/or a cooling battery. The cooler units and the at least one heater-cooler unit may comprise a plurality of pipes for circulating a liquid. The pipes may be enclosed by flanges. When a temperature of liquid circulated in the cooler units and/or the at least one heater-cooler unit differs from a temperature of the surrounding air, condensed water may be formed and may be received by a collector. The collector may be connected to the irrigation system.

The at least one heater-cooler unit being arranged to cool and/or heat air in the structure may comprise the at least one heater-cooler unit being arranged to exchange heat with the air in the structure.

The cooler units being arranged to cool air in the structure may comprise the cooler units being arranged to exchange heat with the air in the structure.

In one embodiment, the arrangement comprises a piping system, the piping system being arranged to circulate fluid, wherein the fluid may be a cooling fluid and/or a heating fluid. The piping system may be arranged in the structure and arranged to exchange heat and/or cold with air in the structure. The piping system may be connected to the subterranean thermal energy storage, the at least one heater-cooler unit, the cooler unit arranged in the attic, the external cooler unit, and/or the irrigation system. The piping system may comprise a plurality of pipes. The piping system may be referred to as a circulation system.

Cooling liquid may be defined as a liquid of a temperature lower than a temperature of a medium that is to be cooled. Heating liquid may be defined as a liquid of a temperature higher than a temperature of a medium that is to be heated. The cooling and/or the heating liquid are arranged to be retrieved from the subterranean thermal energy storage. After having been used for cooling and/or heating, the cooling and/or the heating liquid are arranged to be returned to the subterranean thermal energy storage. Liquid and fluid may be used interchangeably herein.

In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

In the following, numbered exemplifying arrangements and method are provided. The numbered exemplifying arrangements and method are not to be seen as limiting the scope of the invention, which is defined by the appended claims.
1. An exemplifying arrangement for controlling an indoor climate of a structure comprising an area for cultivation, the arrangement comprising:

the structure, a plurality of LED:s arranged to illuminate the area for cultivation, a plurality of solar cells arranged in connection to the structure and arranged to supply the plurality of LED:s with power,

a heating-cooling system arranged in the structure and a subterranean thermal energy storage connected to the heating-cooling system,

wherein the heating-cooling system is arranged to cool air in the structure by transporting heat from the air in the structure into the subterranean thermal energy storage, and/or

wherein the heating-cooling system is arranged to heat air in the structure by transporting heat from the subterranean thermal energy storage into the structure.
2. The exemplifying arrangement according to claim 1, further comprising:

the subterranean thermal energy storage having a vertical temperature gradient and an internal combined heating and cooling machine,

said internal combined heating and cooling machine being adapted for retrieving a fluid having a first temperature from the energy storage, and returning heated fluid having a second higher temperature and cooled fluid having a third lower temperature, and

the plurality of solar cells being arranged to supply the internal combined heating and cooling machine with power.
1. Method for controlling an indoor climate of a structure comprising an area for cultivation, the method comprising:

a plurality of LED:s illuminating the area for cultivation,

a plurality of solar cells supplying the plurality of LED:s with power,

a heating-cooling system cooling air in the structure by transporting heat from the air in the structure into a subterranean thermal energy storage, and/or

the heating-cooling system heating the air in the structure by transporting heat from the subterranean thermal energy storage into the structure.

1. Cultivation structure comprising an area for cultivation connected to a subterranean thermal energy storage, the structure comprising:
a heating-cooling system for controlling an indoor climate of the structure,
wherein the heating-cooling system is arranged to cool air in the structure by transporting heat from the air in the structure into the subterranean thermal energy storage, and
wherein the heating-cooling system is arranged to heat air in the structure by transporting heat from the subterranean thermal energy storage into the structure.

2. Cultivation structure according to claim 1, further comprising:
the subterranean thermal energy storage having a vertical temperature gradient,
the heating-cooling system comprising a circulation system arranged to retrieve a fluid from a first vertical level in the subterranean thermal energy storage, to circulate the fluid in the structure such that heat and/or cold is exchanged between the fluid and the air in the structure, and to return the fluid to a second vertical level in the subterranean thermal energy storage.

3. Cultivation structure according to any one of the preceding claims, further comprising:
a plurality of light sources arranged to illuminate the area for cultivation, and a plurality of solar cells arranged in connection to the structure and arranged to supply the plurality of light sources with power.

4. Cultivation structure according to any one of the preceding claims, further comprising:
the heating-cooling system comprising a control system being arranged to control the indoor climate and being arranged to control at least one of humidity, temperature, light, and carbon dioxide in the cultivation structure.

5. Cultivation structure according to any one of the preceding claims, further comprising:
the control system comprising a plurality of measuring units arranged to measure at least one of temperature, humidity, light, and carbon dioxide.

6. Cultivation structure according to any one of the preceding claims, further comprising:
the subterranean thermal energy storage having a vertical temperature gradient and an internal combined heating and cooling machine,
said internal combined heating and cooling machine being adapted for retrieving a fluid having a first temperature from the energy storage, and returning heated fluid having a second higher temperature and cooled fluid having a third lower temperature, and
the plurality of solar cells being arranged to supply the internal combined heating and cooling machine with power.

7. Cultivation structure according to any one of the preceding claims, further comprising:
the solar cells being at least partly translucent to sun light.

8. Cultivation structure according to any one of the preceding claims, further comprising at least one of:
the solar cells being arranged on top of the structure, and
the solar cells being arranged on sides of the structure.

9. Cultivation structure according to any one of the preceding claims, further comprising:
the structure being at least partly opaque.

10. Cultivation structure according to any one of the preceding claims, further comprising
a roof of the structure being at least one from the group of: transparent and dome-shaped.

11. Cultivation structure according to any one of the preceding claims, further comprising:
the structure being at least one from a building, a part of a building, a green house, a tunnel, a part of a tunnel, a covered pit, and an extraterrestrial covered crater.

12. Cultivation structure according to any one of the preceding claims, further comprising at least one of:
the structure comprising at least one mirror,
at least a part of an inside of the structure having a reflective coating, and
at least a part of the inside of the structure having a fluorescent coating.

13. Cultivation structure according to any one of the preceding claims, wherein
the structure comprises a plurality of climate zones, the climate zones having different temperatures.

14. Cultivation structure according to claim 13, the climate zones being vertically and/or horizontally arranged.

15. Cultivation structure according to any one of the preceding claims, further comprising the heating-cooling system comprising at least one heater-cooler unit being arranged to retrieve water from the air of the structure by transforming vapor in the air of the structure into water.

16. Cultivation structure according to any one of the preceding claims, further comprising the heating-cooling system comprising a cooler unit arranged in connection to the structure,
wherein the cooler unit is arranged to retrieve heat from air outside the structure, and
wherein the heating-cooling system is arranged to transport the retrieved heat into the subterranean thermal energy storage.

17. Cultivation structure according to any one of claims 15-16, further comprising:
an irrigation system, the irrigation system being connected to the heating-cooling system and arranged to transport retrieved water from the heating-cooling system to the area for cultivation.

18. Cultivation structure according to claim 17, further comprising a rain collector arranged to retrieve water from rain, the rain collector being connected to the irrigation system and/or the heating-cooling system.

19. Cultivation structure according to any one of claims 17-18, the irrigation system and/or the heating-cooling system being connected to an external water system and being arranged for providing retrieved water to the external water system.

20. Cultivation structure according to any one of claims 17-19, further comprising:
the area for cultivation comprising a plurality of sub-areas, the sub-areas being arranged at a plurality of levels in the structure, and at least one of:
the plurality of light sources being arranged to illuminate the plurality of sub-areas, and
the irrigation system being arranged to irrigate the plurality of sub-areas.

21. Cultivation structure according to any one of the preceding claims, further comprising:
an aquaculture connected to the area for cultivation.

22. Cultivation structure according to any one of the preceding claims, further comprising: the area for cultivation comprising a hydroculture system.

23. Method for operating a cultivation structure comprising an area for cultivation, the method comprising:
a heating-cooling system cooling air in the structure by transporting heat from the air in the structure into a subterranean thermal energy storage, and/or
the heating-cooling system heating the air in the structure by transporting heat from the subterranean thermal energy storage into the structure.

24. Method according to claim 23, further comprising a circulation system:
retrieving a fluid from a first vertical level in the subterranean thermal energy storage,
circulating the fluid in the structure such that heat and/or cold is exchanged between the fluid and the air in the structure, and
returning the fluid to a second vertical level in the subterranean thermal energy storage.
